(19) United States
(12) Patent Application Publication
(10) Pub. No.: US 2005/0101490 A1
(43) Pub. Date: May 12, 2005

(54) Cellulosic suspensions of alkali formate and method of using the same

(76) Inventor: Daniel P. Vollmer, Lafayette, LA (US)

Correspondence Address: LOCKE LIDDELL & SAPP LLP, 600 TRAVIS, 3400 CHASE TOWER, HOUSTON, TX, 77002-3095, US

(21) Appl. No.: 10/911,038

(22) Filed: Aug. 4, 2004

Related U.S. Application Data
(63) Continuation-in-part of application No. 10/705,180, filed on Nov. 11, 2003.

(51) Int. Cl. C09K 7/02

(52) U.S. Cl. 507/100

(57) ABSTRACT

A fluidized cellulosic polymer suspension of a cellulosic polymer in an alkali formate containing solution is particularly efficacious in the thickening of brines, particularly high density brines, in the recovery of oil and/or gas from a subterranean formation. The alkali formate containing solution preferably contains potassium formate, cesium formate or a mixture thereof. A fluid loss pill containing the cellulosic polymer suspension may further contain a crosslinking agent and glycol.

This application is a continuation-in-part application of U.S. application Ser. No. 10/705,180, filed on Nov. 11, 2003.

### FIELD OF THE INVENTION

The present invention is directed to compositions for thickening aqueous fluids, including brines, and methods of using the same, especially in oilfield operations.

### BACKGROUND OF THE INVENTION

Brines are commonly used to exploit oil and gas from such subterranean petroliferous formations as drilling, drill-in, hydraulic fracturing, work-over, packer, well treating, testing, spacer, acid stimulation, acid diverting, or hole abandonment fluids because of their wide density ranges. Brines commonly used as completion and workover fluids are tabulated in Table I with their respective density range:

TABLE I

| | Brine Density Range, pounds per |
|---|---|
| Aqueous Brine Composition | gallon (ppg) |
| NH₄Cl | 8.3-9.6 |
| KCl | 8.3-9.7 |
| KHCO₂ | 8.3-13.3 |
| NaCl | 8.3-10.0 |
| NaHCO₂ | 8.3-10.9 |
| NaBr | 8.3-12.7 |
| NaCl/NaBr | 10.0-12.7 |
| CaCl₂ | 8.3-11.6 |
| CaBr₂ | 8.3-15.3 |
| CaCl₂/CaBr₂ | 11.6-15.1 |
| CaCl₂/CaBr₂/ZnBr₂ | 15.1-19.2 |
| CaBr₂/ZnBr₂ | 14.2-19.2 |
| CsHCO₂ | 8.3-19.2 |

During completion and workover operations, when the hydrostatic pressure of the fluid exceeds the pressure of the formation, the fluid brines tend to escape into the formation. Once they have escaped, these fluids are not capable of being utilized in any stage of the completion or workover process. Thus, it is common to thicken a small volume of brine or water with a water soluble polymer (a fluid loss pill) and then pump the thickened formulation at the formation in order to alleviate fluid losses. Typical thickening polymers are cellulosic polymers, such as hydroxylethylcellulose (HEC) and carboxylmethyl hydroxylethylcellulose (CMHEC).

One of several problems may occur when attempting to thicken or viscosity such aqueous systems. One such problem is the formation of fisheyes. At low salt concentration, fisheyes occur. A fisheye, lump, or microgel, occurs when the polymer hydrates too quickly, causing a gel coating to surround the dry polymer, thereby preventing solubilization. A second problem lies in the difficulty in effectuating viscosification. At high salt concentrations, the thickening polymer is unable to dissolve to effectuate thickening. Often, the time period to viscosify is overly long; in other instances, viscosification fails to occur over prolonged times. Such problems may occur in light of the amount of water within the brine. See R. F. Scheuerman, “Guidelines for HEC Polymers for Viscosifying Solids-Free Completion and Workover Brines,” Journal of Petroleum Technology, February, 1983, p. 306-314.

Methods to viscosify brines and to alleviate the formation of fisheyes by the use of water soluble polymers has been reported. For example, U.S. Pat. No. 4,330,414 discloses mixing HEC in a solvating agent comprising a water miscible polar organic liquid and dispersing the resulting mixture in a brine. This procedure thickens brines and alleviates the formation of fisheyes more rapidly as compared to a similar procedure not employing a solvating agent. Unfortunately, the method promotes bottom settling and possible hardening of the polymer. However, the inventors do teach the addition of organophilic clays to aid suspension, but clays cause formation damage when this invention is used as a fluid loss pill.

U.S. Pat. No. 5,228,909 discloses a stable HEC mixture in a 28 to 35 weight percent solution of sodium formate. While the 28 weight percent lower limitation is reported to be necessary to prevent gelling of the HEC at ambient temperature, such systems, when cooled to 35° F., evidence gelling; the gelled state remains when the system is heated to 75° F. This is unacceptable, especially when the mixture is stored in an uncontrolled climate, the typical climatic state during oil and gas recovery operations. Another problem is attributable to crystallization of the sodium formate. This occurs at near sodium formate saturation and manifests itself as a solid mass.

In D. Vollmer et al., “HEC Precipitation Solutions”, Hart's E&P, January 2000, pp. 98-100, the author discusses the precipitation of HEC from sodium, potassium and cesium formate solutions at elevated temperatures. HEC is reported as being incapable of viscosifying these formate brines at densities far from saturation at 80° F. (10.5 ppg and above for potassium formate solutions) and even further at 120° F. (10.3 ppg and above at 120° F.). The precipitates ultimately harden, thereby effecting the overall efficacy of the treatment. A system capable of thickening brines, especially high density brines, without precipitation of the cellulosic polymer or alkali formate is therefore desired.

In addition, in light of the extreme shear, pressure and temperature variances encountered during drilling and completion operations, especially when completing very deep wells, it is important that such cellulosic polymers are stable at high temperatures and not de-polymerize. Such depolymerization results in loss in effectiveness of the fluid.

### SUMMARY OF THE INVENTION

A fluidized cellulosic polymer suspension of a cellulosic polymer in an alkali formate containing solution is particularly efficacious in the thickening of brines and is useful, particularly in high density brines, in the recovery of oil and/or gas from a subterranean formation. Especially preferred as alkali formate are potassium formate, cesium formate, or a mixture thereof.

The alkali formate containing solution preferably has between from about 40 to about 75 weight percent of alkali formate. In one embodiment, the fluidized cellulosic polymer is suspended, at 70° F., in an alkali formate solution containing 40% or more (based on the total weight of water and salt of alkali formate dissolved in water) of alkali formate. In one embodiment, no more than 25 weight percent of the alkali formate in the solution is sodium formate, the remainder being potassium formate, cesium formate, or a mixture thereof. In a preferred embodiment, the true crystallization temperature (TCT), API Recommended Practice 13 J, Second Edition, March 1996, of the alkali formate solution is less than or equal to 20°, more preferably less than or equal to 18° F., most preferably less than or equal to 10° F., ideally less than or equal to 0° F.

The cellulosic polymer is preferably either anionic or non-ionic, most preferably anionic modified or nonionic modified cellulose, including carboxymethylhydroxyethyl cellulose (CMHEC) or hydroxyethyl cellulose (HEC), as well as crosslinked HEC, such as crosslinked HEC with glycoxal.

The cellulosic polymer suspension, when added to a base brine or water, is highly effective when used as a treatment fluid, or fluid loss pill, for reducing fluid loss from the wellbore. In a preferred embodiment, a base brine having a density greater than or equal to 10.5 ppg at 70° F. is employed. The presence of the alkali formate enhances the thermal stability of the treatment fluid. Thus, fluid loss from the wellbore may be reduced by injecting into the wellbore the thickened product obtained by introducing the cellulosic polymer suspension to a base brine or water.

In a preferred embodiment, the fluid loss pill contains, in addition to the cellulosic polymer suspended in the alkali formate solution and the base brine or water, a crosslinking agent and a polyol. The crosslinking agent preferably contains titanium, zirconium or boron.

### BRIEF DESCRIPTION OF THE DRAWINGS

FIG. 1 shows the effect on thermal stability of fluid loss pills prepared using the cellulosic polymeric suspensions.

FIG. 2 shows the effect of lower pH on initial fluid loss using the fluid loss pills prepared using the cellulosic polymeric suspensions.

FIG. 3 shows the effect of higher pH on initial fluid loss using the fluid loss pills prepared using the cellulosic polymeric suspensions.

FIGS. 4 and 5 show the effect of polyols on the thermal stability of the fluid loss pill prepared from the cellulosic polymeric suspensions of the invention.

### DETAILED DESCRIPTION OF THE PREFERRED EMBODIMENTS

The cellulosic polymer suspension of the invention is highly useful in the thickening of brines, especially high density brines, i.e., those brines having a density greater than or equal to 10.5, preferably between 11.6 and 14.2, pounds per gallon (ppg) at 70° F. The cellulosic suspension, free of fisheyes, lumps and microgels, is pourable.

The cellulosic polymer suspensions of the invention are especially useful in brines to clean the wellbore during washing, milling and reaming operations. In addition, it can be used during displacement and gravel pack operations. A major advantage of the suspensions of the invention is that they are capable of viscosifying brine fluids without the need for special rig equipment or shear devices.

The cellulosic polymer is typically either non-ionic or anionic. Preferred anionic cellulosic polymer is carboxymethylhydroxyethyl cellulose and preferred non-ionic cellulosic polymer is hydroxyethyl cellulose. The cellulosic polymer is preferably either anionic or non-ionic, most preferably anionic modified or nonionic modified cellulose, including carboxymethylhydroxyethyl cellulose (CMHEC) or hydroxyethyl cellulose (HEC), as well as crosslinked HEC, such as crosslinked HEC with glycoxal. Particularly preferred are crosslinked HECs, such as HEC 10 and HEC 10HV, products of The Dow Chemical Company, and as non-crosslinked HEC, 210 HHW, a product of Aqualon. The HEC 10HV provides a higher viscosity per pound that HEC 10. The amount of cellulosic polymer suspended in the alkali formate salt solution is typically between from about 5 to about 23, preferably from about 10 to about 20, weight percent.

The alkali formate solution serves as a carrier liquid for the delivery of the cellulosic polymer to the workover or completion fluid brine. Further, as a component of the fluid loss control pill, the alkali formate solution serves to thicken the cellulosic polymer, the alkali formate solution thereby increasing the thermal stability of the treatment fluid.

Suitable alkali formates include cesium formate and potassium formate. The amount of alkali formate in the alkali formate solution, to which is introduced the cellulosic polymer, is between from about 40 to about 75 weight percent. The greater the alkali formate in the solution, the greater the amount of cellulosic polymer may be used to fluidize the suspension. Higher amounts of cellulosic polymer, however, increase the mixing time required to thicken the brine or water.

The alkali formate may further include a mixture of one of calcium formate (a byproduct produced when the brine is a calcium brine), cesium formate and/or potassium formate with sodium formate (a byproduct produced when the brine is a sodium brine). For example, the fluidized cellulosic polymer may be suspended, at 70° F., in 40% or more (based on the total weight of water and salt of alkali formate dissolved in water) of alkali formate solution, wherein the alkali formate solution contains no more than 25% of sodium formate. For example, the alkali solution may contain 25% sodium formate and 15% potassium formate.

The alkali formate salt solution is inherently shale inhibitive, does not require potassium chloride, can be used directly with water or brine, and, by passing the EPA Static Sheen test and Oil and Grease test, is environmentally friendly. For details describing the shale inhibitive characteristics of formates, refer to J. H. Hallman, et al, “Enhanced Shale Stabilization with Very Low Concentration Potassium Formate/Polymer Additives,” SPE 73731, February 2002.

The alkali formate salt solution employed in the invention is characterized by a very low crystallization temperature (TCT), API 13 J. The TCT of the alkali formate solution used in the invention is preferably less than or equal to 20°, more preferably less than or equal to 18° F., most preferably less than or equal to 10° F., ideally less than or equal to 0° F. Such TCTs are dramatically lower than those which characterize a sodium formate salt solution. The TCTs for sodium formate are set forth in Table II below:

TABLE II
Crystallization Temperatures for Sodium Formate Solutions

| Density, ppg | | | |
|---|---|---|---|
| @ 70° F. | Specific Gravity | Wt. % NaHCO₂ | TCT, ° F. |
| 8.99 | 1.079 | 12.3 | 18 |
| 9.63 | 1.155 | 22.2 | 2 |
| 10.12 | 1.214 | 29.9 | 20 |
| 10.55 | 1.265 | 37.5 | 49 |
| 10.73 | 1.287 | 40.2 | 54 |
| 10.81 | 1.297 | 41.5 | 56 |
| 10.91 | 1.309 | 43.0 | 59 |

and is markedly distinct from that of potassium formate, set forth in Table III:

TABLE III
Crystallization Temperatures for Potassium Formate Solutions

| Density, ppg | | | |
|---|---|---|---|
| @ 70° F. | Specific Gravity | Wt. % KHCO₂ | TCT, ° F. |
| 9.04 | 1.084 | 15.1 | 19 |
| 10.03 | 1.205 | 32.4 | −15 |
| 10.43 | 1.251 | 38.4 | −28 |
| 10.78 | 1.293 | 44.4 | <−30 |
| 11.68 | 1.401 | 57.2 | <−30 |
| 12.18 | 1.461 | 63.5 | −36 |
| 12.50 | 1.499 | 67.5 | −12 |
| 12.98 | 1.557 | 73.5 | 9 |
| 13.17 | 1.580 | 76.0 | 28 |

In an alternative embodiment, a suspension stabilizer, such as xanthan gum, may further be incorporated in the alkali formate salt solution. Alternatively, other suspension stabilizers such as carboxymethylhydroxypropyl guar (CMPHG), carboxymethylcellulose (CMC), guar gum, and sodium alginate may further be employed. Typically, the suspension stabilizer is unnecessary because the brine is normally heavier than the polymeric suspension, therefore, settling of the cellulosic polymer is not possible. When however it is employed, the amount of stabilizer present in the alkali formate solution is typically between from about 0.03 to about 1.0 percent by weight.

The amount of cellulosic polymer introduced into the workover or completion brine to increase the brine viscosity is dependent upon the composition and density of the brine, and typically requires between from about 0.5 to about 8.0, preferably between from about 1.0 to about 5 pounds per barrel (bbl).

Further, the cellulosic suspension may be used in combination with water or brine to form the fluid loss pill, which may then be pumped into a wellbore in order to reduce the fluid loss from the wellbore into the subterranean formation. The brine may be saturated or unsaturated brine. By saturated brine, it is understood that the brine is saturated with at least one salt. Brines having a density greater than or equal to 10.5, preferably between 11.6 and 14.2, ppg at 70° F. may be preferred. The brine of the fluid loss pill must be compatible with the completion fluid brine to avoid salt precipitation. The brine in the fluid loss pill may or may not be the same as the completion fluid brine.

The cellulosic suspension, polyol, and brine or water may be prepared off-site and shipped to the desired subterranean formation to be treated. Settling of the polymeric suspension during transportation is generally not possible since the formate density is greater than the density of the cellulosic polymer. The fluid loss pill of the invention alleviates fluid loss, particularly completion fluids, from the wellbore.

The fluid loss pill should have a density equal to or greater than the density of the completion brine in order that the fluid loss pill may remain in contact with the formation wall at the desired depth in the wellbore and not be displaced by the completion brine. Typically, the amount of fluid loss pill added to the completion brine is dependent on hydrostatic pressure, pressure, the volume of the hole to cover the perforation, formation permeability, pill viscosity at the bottom hole temperature and thermal degradation rate of the pill.

In a preferred embodiment, the fluid loss pill contains a crosslinker to assist in crosslinking of the functional groups of the cellulosic polymer. Examples of suitable crosslinking agents include, but are not limited to, metal ions such as aluminum, antimony, zirconium and titanium-containing compounds, including the so-called organometallics. Transition metals such as zirconium and titanium crosslinkers are preferred as well as borate ion donating materials, such as those described in U.S. Pat. No. 4,797,216, U.S. Pat. No. 5,067,565 and U.S. Pat. No. 5,789,351. When used, the amount of crosslinking additive is preferably present in the range of from about 0.05% to in excess of 10% by weight of the fluid loss pill. Preferably, the concentration of crosslinking agent is in the range of from about 0.1% to about 5% by weight of the fluid loss pill.

Further, the fluid loss pill may contain a water insoluble starch to control the loss of fluid. Suitable water-insoluble starches are those conventionally used in the art, such as starch crosslinked with epichlorohydrin, modified starches such as hydroxypropyl starch, optionally crosslinked with epichlorohydrin, etc.

Typically, the pH of the fluid loss pill may need to be adjusted with an acid or base. Typical acids are fumaric, hydrochloric, acetic and citric. Bases can be magnesium hydroxide, magnesium oxide, calcium hydroxide, calcium oxide, sodium hydroxide, potassium hydroxide, sodium carbonate, and potassium carbonate. The desired pH is buffered to be between from about 3.0 to about 12.0. Depending on the acid type, the acid is typically added in an amount between from about 0.2 to 0.5 lb/ppb for calcium brines and from about 2 to about 5 ppb for other types of brine and water. Bases are added at 0.2 to 2 ppb for all brines and water. Generally, buffering of the treated brine at a higher pH may cause greater initial fluid loss but greater thermal stability than treated brine buffered at lower pH.

Further, thermal stability of the fluid loss pill can further be imparted by addition of a polyol. Suitable polyols include glycerol, glycols and polyglycols. The glycols include commonly known glycols such as ethylene glycol, propylene glycol and butylene glycol. The polyglycols can be selected from a wide range of known polymeric polyols that include polyethylene glycol, poly(1,3-propanediol), poly(1,2-propanediol), poly(1,2-butanediol), poly(1,3-butanediol), poly(1,4-butanediol), poly(2,3-butanediol), co-polymers, block polymers and mixtures of these polymers. A wide variety of polyglycols are commercially available and include polyethylene glycol and are usually designated by a number that roughly corresponds to the average molecular weight. Examples of useful commercially available polyethylene glycols include polyethylene glycol 600, polyethylene glycol 1000, polyethylene glycol 1500, polyethylene glycol 4000 and polyethylene glycol 6000. Preferably the polymeric polyols for use in the present invention are selected to have a number average molecular weight, Mₙ, of about 150 to about 18,000 Daltons. More preferably, the polymeric polyols are selected to have number average molecular weight of about 190 to about 10,000 D. Yet most preferably, the polymeric polyols are selected to have number average molecular weight of about 500 to about 7,000 D.

Polyglycols with a molecular weight of about 1000 are freely soluble in water. But as the molecular weight of the polyol increases, its water solubility decreases. Very high molecular weight polyols can be used in the present invention. However, phase separation may occur when the fluid includes the high molecular weight polyols, water and brine. An emulsifier or a surfactant can be employed to ensure that a biphasic fluid maintains fluid consistency or homogeneity. Any of the emulsifying agents and surfactants commonly known and used in the art can be used in the present invention. Specific examples include: alkoxylated lanolin oil, castor oil ethoxylate, diethylene glycol monotallowate, ethoxylated fatty alcohols, ethoxylated nonylphenol, glyceryl tribehenate, polyglyceryl-3 diisostearate and tallow amine ethoxylates.

The inclusion of polyols having a chain length greater than about 16 glycol monomeric repeating units, or a polymer composition exhibiting a number average molecular weight greater than about 1,000 up to about 18,000 dramatically increases the viscosity of the fluid. A variety of polymers can be used in fluids to increase the viscosity of the fluid in a “normal wellbore” typically less than 10,000 ft. deep (3050 m). However, most polymers do not provide the same viscosifying influence in very deep wells. Specific polyols, for example, polyols having a molecular weight of about 18,000 used in accordance with the present invention can maintain a viscosity of greater than about 180 cp at about 425° F. (218° C.) at 511 sec⁻¹ shear rate.

The amount of polyol, in weight percent of the total weight of the fluid loss pill, is generally between from about 15 to about 95, preferably from about 25 to about 90, weight percent.

The following examples will illustrate the practice of the present invention in its preferred embodiments. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow.

### EXAMPLES

In Examples 1-21, tests were performed with two types of HEC: A HEC that has been crosslinked with glyoxal (HEC 10 obtained from The Dow Chemical Company) and a non-crosslinked HEC (obtained from Aqualon as 210 HHW). The examples teach how to thicken brines (about 350 ml) using a cellulosic polymer suspended in an aqueous solution of alkali formate without limiting the scope of the invention. The examples illustrate thickening of brines with minimization of fisheyes by use of the cellulosic suspensions.

### Example Nos. 1-14

Inventive viscosifier compositions are prepared by mixing by weight the cellulosic polymer in an aqueous solution of sodium formate, potassium formate or cesium formate or a mixture thereof. The cellulosic polymer was HEC 10, 210 HHW or carboxymethylhydroxyethyl cellulose (CMHEC). The concentration of the alkali formate in the salt solution is above 40% by weight to maintain the suspension. Table IV shows the results of the tests.

TABLE IV

| Ex. | Cellulosic | Wt. | | |
|---|---|---|---|---|
| No. | Polymer | % | Solution | Comments |
| 1 | HEC 10 | 10 | 90% of 11.0 ppg | Thin liquid at 72° F., Paste at 50° F., |
| | | | KHCO₂ | Gelled at 30° F. |
| 2 | HEC 10 | 15 | 85% 11.3 ppg | Thin liquid at 72° F., Paste at 30° F. |
| | | | KHCO2 | |
| 3 | HEC 10 | 20 | 80% of 11.8 ppg | Liquid at 72° F., Thin Paste at 0° F. |
| | | | KHCO₂ | |
| 4 | HEC 10 | 15 | 85% of 11.8 ppg | Thin liquid at 72° F., Thick liquid at |
| | | | KHCO2 | 30° F. for 3 days. |
| Comp. | 210 HHW | 10 | 90% of 10.0 ppg | Gelled within 1 minute |
| Ex. 5 | | | NaHCO₂ | |
| 6 | 210 HHW | 10 | 90% of 11.5 ppg | Liquid at 72° F., Thick liquid at 0° F. |
| | | | KHCO₂ | |
| 7 | 210 HHW | 16 | 84% of 11.8 ppg | Liquid at 72° F. and at 30° F. |
| | | | KHCO2 | |
| Comp. | HHW210 | 20 | 80% of 10.9 ppg | Liquid at 72° F., Solid at 50° F. |
| Ex. 8 | | | NaHCO₂ | |
| 9 | 210 HHW | 20 | 80% of 50/50 10.5 | Liquid at 72° F., thick paste at 0° F. |
| | | | ppg NaHCO₂/12.0 | |
| | | | ppg KHCO₂ | |
| Comp. | 210 HHW | 25 | 75% of 13.1 ppg | Paste at 72° F. |
| Ex. 10 | | | KHCO₂ | |
| 11 | CMHEC | 10 | 90% of 11.5 ppg | Thick Liquid at 72° F. |
| | | | KHCO₂ | |
| Comp. | HEC 10 | 10 | 90% of 11.3 ppg | Gelled within 1 minute |
| Ex. 12 | | | KC₂H₃O₂ (62.5 | |
| | | | wt %) | |
| 13 | HEC 10 | 10 | 90% of 15.6 ppg | Thick Liquid at 72° F. |
| | | | CsHCO₂ | |
| 14 | CMHEC | 14 | 86% of 12.2 ppg | Liquid at 72° F., Thick liquid at 0° F. |
| | | | KHCO₂ | |

Note that Comp. Ex. 12, having densities and salt concentration greater than Example No. 1, is not suited as a carrier liquid for HEC.

### Example No. 15

Two solutions were prepared having identical composition. One solution (Solution #1) contained 16.6 pounds per barrel (ppb) of Example No. 9 added to an 11.6 pounds per gallon (ppg) calcium chloride solution while stirring using an overhead stirrer. This solution contained 13.6 ppb of 12.0 ppg potassium formate and sodium formate solution and 3 ppb of HEC 10. The other solution (Solution #2) contained 6.8 ppb of 12.0 ppg of potassium formate solution, 6.8 ppb of 10.5 ppg sodium formate solution added to the 11.6 ppg calcium chloride and subsequently, 3 ppb of dry HEC 10. Both solutions, having identical compositions, were allowed to stir and their thickness measured using a Fann 35 rheometer (B1 bob) at intervals. Table V shows the results wherein the greater the reading from the Fann 35 rheometer, the greater the fluid's viscosity. Note that Solution #1 viscosifies within 30 minutes of stirring while Solution #2 requires an hour to achieve nearly identical viscosity.

TABLE V
Viscosification of 11.6 ppg Calcium Chloride Solution

| | Solution #1 | | Solution #2 | |
|---|---|---|---|---|
| Fann 35 | Stirred | Stirred | Stirred | Stirred |
| RPM | 30 min. | 1 hr. | 30 min. | 1 hr. |
| 600/300 | OS/OS | OS/OS | 311/237 | OS/OS |
| 200/100 | 301/248 | 294/241 | 202/158 | 293/240 |
| 6/3 | 118/100 | 114/94 | 67/55 | 115/96 |
| pH | 7.2 | 7.3 | 7.1 | 7.1 |
| Measured Temp. | 76° F. | 84° F. | 72° F. | 77° F. |

OS = off-scale or too thick to measure

### Example 16

Two solutions were prepared having identical composition. One solution (Solution #3) had 20 ppb of Example No. 2 above added to a 14.2 ppg calcium bromide solution while stirring using an overhead stirrer. This solution contained 17 ppb of 11.3 ppg potassium formate and 3 ppb of HEC 10. The other solution (Solution #4) had 17 ppb of 11.3 ppg potassium formate added to the 14.2 ppg calcium bromide and subsequently, 3 ppb of dry HEC 10. Both solutions having identical compositions were allowed to stir and their thickness measured using a Fann 35 rheometer (B1 bob) at various times. Table VI shows that Solution #3 fully viscosifies within 30 minutes of stirring while Solution #4 shows little change at 3 hours with very little viscosification.

TABLE VI
Viscosification of 14.2 ppg Calcium Bromide Solution

| | Solution #3 | | Solution #4 | | |
|---|---|---|---|---|---|
| Fann 35 | Stirred | Stirred | Stirred | Stirred | Stirred |
| RPM | 30 min. | 1 hr. | 1 hr. | 2 hr. | 3 hr. |
| 600/300 | OS/289 | OS/285 | 12/6 | 23/12 | 32/18 |
| 200/100 | 257/211 | 252/206 | 5/2 | 8/4 | 13/7 |
| 6/3 | 105/86 | 95/78 | <1/<1 | <1/<1 | 1/<1 |
| pH | 4.6 | 4.6 | 4.8 | 4.9 | 4.8 |
| Measured Temp. | 71° F. | 75° F. | 70° F. | 71° F. | 68° F. |

Note:
OS = off-scale or too thick to measure

### Example 17

Two solutions were prepared having identical composition. One solution (Solution #5) had 30 ppb of Example No. 13 added to a 15.1 ppg calcium chloride/calcium bromide solution while stirring using an overhead stirrer. The other solution (Solution #6) had 27 ppb of 15.6 ppg cesium formate added to the 15.1 ppg calcium chloride/calcium bromide solution and subsequently, 3 ppb of dry HEC 10. Both solutions having identical compositions were allowed to stir and their thickness measured using a Fann 35 rheometer (B1 bob) at various times. Table VII shows the results noting that Solution #5 fully viscosifies at 1 hour of stirring while Solution #6 shows no viscosification at 2 hours.

TABLE VII
Viscosification of 15.1 ppg Calcium
Chloride/Calcium Bromide Solution

| | Solution #5 | | Solution #6 | |
|---|---|---|---|---|
| Fann 35 | Stirred | Stirred | Stirred | Stirred |
| RPM | 1 hr. | 1.5 hr. | 1 hr.. | 2 hr. |
| 600/300 | OS/OS | OS/OS | 48/24 | 50/25 |
| 200/100 | OS/284 | OS/313 | 16/8 | 17/8 |
| 6/3 | 119/97 | 111/81 | <1/<1 | <1/<1 |
| pH | 6.3 | 6.3 | 6.4 | 6.4 |
| Measured Temp. | 86° F. | 96° F. | 86° F. | 84° F. |

Note:
OS = off-scale or too thick to measure

### Example 18

Two solutions were prepared having identical composition. One solution (Solution #7) had 18.75 ppb of Example No. 7 added to a 19.2 ppg calcium bromide/zinc bromide solution while stirring using an overhead stirrer. This solution contained 15.75 ppb of 11.8 ppg potassium formate and 3 ppb of 210 HHW. The other solution (Solution #8) had 15.75 ppb of 11.8 ppg potassium formate added to the 19.2 ppg calcium bromide/zinc bromide solution and subsequently, 3 ppb of dry 210 HHW. Both solutions having identical compositions were allowed to stir and their thickness measured using a Fann 35 rheometer (B1 bob) at various times. Table VIII shows the results noting that Solution #7 fully viscosifies at 2.5 hours of stirring while Solution #8 shows little change at the same time. Solution #7 was allowed to stir for 24 hours and was still thinner than Solution #3 stirring for 30 minutes.

TABLE VIII
Viscosification of 19.2 ppg Calcium Bromide/Zinc Bromide Solution

| | Solution #7 | | | Solution #8 | | |
|---|---|---|---|---|---|---|
| Fann 35 | Stirred | Stirred | Stirred | Stirred | Stirred | Stirred |
| RPM | 30 min. | 2.5 hr. | 3 hr. | 30 min. | 3 hr. | 24 hr. |
| 600/300 | OS/220 | OS/OS | OS/OS | 68/37 | 110/67 | 202/129 |
| 200/100 | 178/127 | 314/245 | 315/250 | 25/13 | 49/29 | 101/67 |
| 6/3 | 39/31 | 111/91 | 111/90 | 1/<1 | 3/2 | 15/10 |
| pH | 1.8 | 1.9 | 1.9 | 1.8 | 1.8 | 1.8 |
| Measured Temp. | 74° F. | 77° F. | 79° F. | 75° F. | 74° F. | 71° F. |

Note:
OS = off-scale or too thick to measure

### Example 19

Two solutions were prepared having identical composition. One solution (Solution #9) had 42 ppb of Example No. 11 added to a 19.2 ppg calcium bromide/zinc bromide solution while stirring using an overhead stirrer. This solution contained 37.8 ppb of 11.5 ppg potassium formate and 4.2 ppb of CMHEC. The other solution (Solution #10) had 37.8 ppb of 11.5 ppg potassium formate added to the 19.2 ppg calcium bromide/zinc bromide solution and subsequently, 4.2 ppb of dry CMHEC. Both solutions having identical compositions were allowed to stir and their thickness measured using a Fann 35 rheometer (B1 bob) at various times. Table IX shows the results noting that Solution #9 fully viscosifies within 1 hour of stirring while Solution #10 shows little change at the same time.

TABLE IX
Viscosification of 19.2 ppg Calcium Bromide/Zinc Bromide Solution

| | Solution #9 | | | Solution #10 | | |
|---|---|---|---|---|---|---|
| Fann 35 | Stirred | Stirred | Stirred | Stirred | Stirred | Stirred |
| RPM | 15 min. | 30 min. | 1 hr. | 30 min. | 1 hr. | 2 hr. |
| 600/300 | OS/OS | OS/OS | OS/OS | 44/22 | 50/25 | 55/29 |
| 200/100 | OS/312 | OS/OS | OS/OS | 15/7 | 17/8 | 19/10 |
| 6/3 | 139/115 | 145/121 | 147/121 | <1/<1 | <1/<1 | <1/<1 |
| pH | 2.3 | 2.3 | 2.3 | 84° F. | 79° F. | 76° F. |
| Measured Temp. | 80° F. | 82° F. | 83° F. | 2.0 | 2.0 | 2.0 |

Note:
OS = off-scale or too thick to measure

### Example 20

A HEC 10 mixture was prepared adding 1 ppb of CMHPG to a 12.0 ppg KHCO₂ and allowing to stir for 45 minutes. The 300 rpm reading from a Fann 35 for this solution was 37. Then, 18% by weight of HEC 10 was added to 82% by weight of the viscosified 12.0 ppg KHCO₂ solution. Although the HEC 10 is lighter than the potassium formate solution, the addition of CMHPG prevents the HEC 10 from concentrating near the surface (reverse from settling) over time. This mixture is called Mixture No. 15.

Two solutions were prepared having identical composition. One solution (Solution#11) had 16.6 ppb of Mixture No. 15 added to a 13.0 ppg calcium chloride/calcium bromide solution while stirring using an overhead stirrer. The 13.0 ppg was prepared by mixing a 15.1 ppg calcium chloride/calcium bromide solution with an 11.6 ppg calcium chloride solution. The composition by weight is 19.7% calcium bromide, 29.2% calcium chloride and the balance being water. The other solution (Solution #12) had 13.6 ppb of the viscosified 12.0 ppg potassium formate added to the 13.0 ppg calcium chloride/calcium bromide solution and subsequently, 3.0 ppb of dry HEC 10. Both solutions having identical compositions were allowed to stir and their thickness measured using a Fann 35 rheometer (B1 bob) at various times. Table X shows the results with Solution #11 having full viscosification within 1 hour of stirring while the other does not.

TABLE X
Viscosification of 13.0 ppg Calcium Chloride/Calcium Bromide Solution

| | Solution #11 | | Solution #12 | | |
|---|---|---|---|---|---|
| Fann 35 | Stirred | Stirred | Stirred | Stirred | Stirred |
| RPM | 1 hr. | 1.5 hr. | 1 hr. | 1.5 hr. | 2 hr. |
| 600/300 | OS/OS | OS/OS | 37/19 | 40/21 | 43/23 |
| 200/100 | OS/260 | OS/265 | 12/6 | 14/7 | 16/8 |
| 6/3 | 125/106 | 117/95 | <1/<1 | <1/<1 | <1/<1 |
| pH | 6.9 | 7.1 | 7.2 | 7.3 | 7.0 |
| Measured Temp. | 81° F. | 85° F. | 76° F. | 75° F. | 76° F. |

Note:
OS = off-scale or too thick to measure

### Example 21

A 14% CMHEC mixture was prepared by weighing 446.2 grams of a 13.1 ppg potassium formate solution, 1 gram of xanthan gum and 132.3 grams of water. The solution was allowed to stir on an overhead stirrer for 20 minutes to allow the xanthan gum to viscosify or thicken the solution. Then another 446.2 grams of 13.1 ppg potassium formate was added and finally 167 grams of CMHEC was added. The final potassium formate density to suspend the CMHEC is 12.2 ppg. Although settling of the CMHEC is impossible, adding xanthan gum as a suspension agent prevented the CMHEC from concentrating at the surface.

To an 11.0 ppg calcium chloride solution, 25 ppb of the CMHEC mixture was added to fully thicken the calcium chloride solution within 30 minutes. The pH of the solution was reduced to 3.5 with fumaric acid and crosslinked with 5 gallons per 1000 gallons of aqueous sodium zirconate solution while stirring. The sodium zirconate serves to crosslink the carboxymethyl group in the CMHEC to form a gel.

### Example 22

Examples 22-26 illustrate the effectiveness of increasing the thermal stability of crosslinked fluid loss pills prepared from the cellulosic polymeric suspensions. In Examples 22-26, the fluid loss pills were prepared by adding, to a 1 bbl equivalent (350 ml) of base brine, between from about 3.5 to about 4.2 ppb of 12% by weight CMHEC slurry in a viscosified 12.0 ppg potassium formate solution while stirring. (This CMHEC slurry is designated as 12% CMHEC.) The 12.0 ppg KHCO₂ was viscosified with 1.0 ppb xanthan gum to prevent the CMHEC from concentrating near the surface due to buoyancy. Mixing occurred for about 15 to about 30 minutes to full viscosification. The pH of the fluid was measured and adjusted, if needed, using fumaric acid or similar acids for pH reduction or magnesium oxide or similar bases to increase the pH. The viscosified systems were then crosslinked with an aqueous solution of zirconium sodium lactate crosslinker, such as XLW-49, a product of BJ Services Company. All densities are reported at 70° F.

The fluid loss pills were evaluated in a high pressure high temperature (HPHT) cell by first soaking an Aloxite disk in the base brine to remove any air and then placing the disk in the cell and pouring the pill on top of the disk. The cell was then placed in the heating jacket and heated to the test temperature (100 psig of nitrogen was used to prevent the fluid from boiling). When the test temperature was obtained, the cell was pressurized to 500 psig, the valve opened and the filtrate volume recorded at various time intervals until a large increase in filtrate volume was observed in a short time interval or until all of the fluid was filtered out from the cell. The thermal stability of the pill was then plotted. A straight line indicates the pill is thermally stable to control fluid losses to the formation.

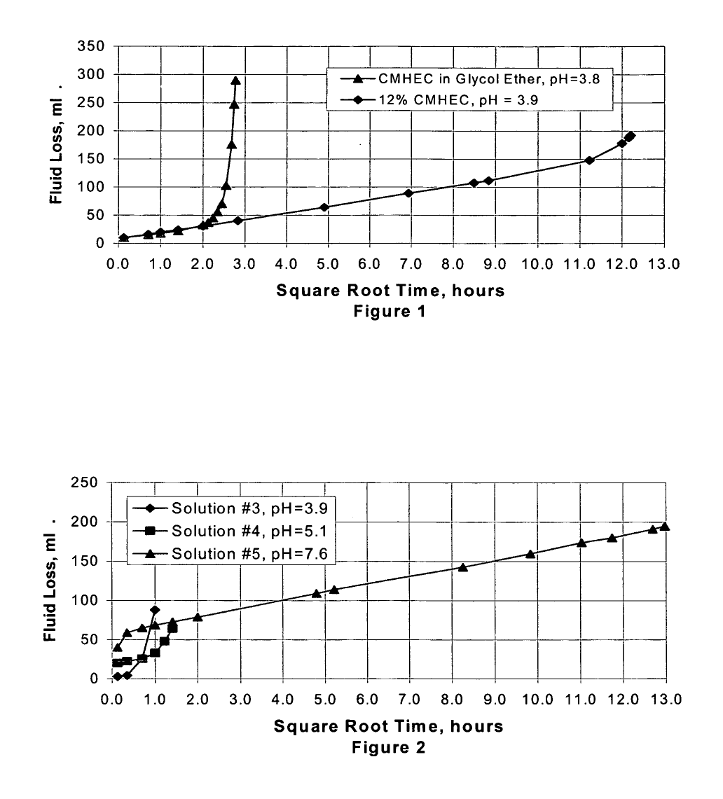

In Example 22, two solutions were prepared by viscosifying a 11.2 ppg CaCl₂ brine solution. (Comparative) Solution #1 used a 2.8 ppg CMHEC slurry in a glycol ether solvent while Solution #2 used the 12% CMHEC. Solution #2 was calculated to contain 3.2% potassium formate by total weight of the solution. Both solutions contained 3.5 ppb of CMHEC. After 30 minutes of stirring to allow the solutions to thicken, fumaric acid was added to both solutions to lower the pH between 3.5 and 4.0. Then the crosslinker was added at 7 gptg (gallons per thousand gallons). A fluid loss test was performed at 225° F. and on a 400 md Aloxite disk until nearly all the fluid was emptied out of the cell or a large increase in filtrate volume was observed in a short time interval. FIG. 1 shows that the solution containing 3.2% potassium formate increased the thermal stability from about 6 hours to over 5 days. In particular, Solution #2 shows breakdown at about 5 days whereas Solution #1 is unable to control losses at about 5 hours.

### Example 23

Three solutions were prepared by viscosifying a 11.6 ppg CaCl₂ brine solution with 29 ppb of the 12% CMHEC (3.5 ppb CMHEC). To one solution (Solution #3), fumaric acid was added to lower the pH to 3.9. To another (Solution #4) the pH was measured to be 5.1 while to the third solution (Solution #5), 0.2 ppb magnesium oxide was added which increased the pH to 7.6. The crosslinker was then added at 7 gptg and a fluid loss test was performed at 250° F. and on a 400 md Aloxite disk until nearly all the fluid was emptied out of the cell or a large increase in fluid was observed in a short period of time. FIG. 2 shows that the Solution #5 was thermally stable for 7 days while the other solutions began to thermally degrade in less than 1 hour. The figure also shows the general trend that lower pH has lower initial fluid loss but is less thermally stable.

### Example 24

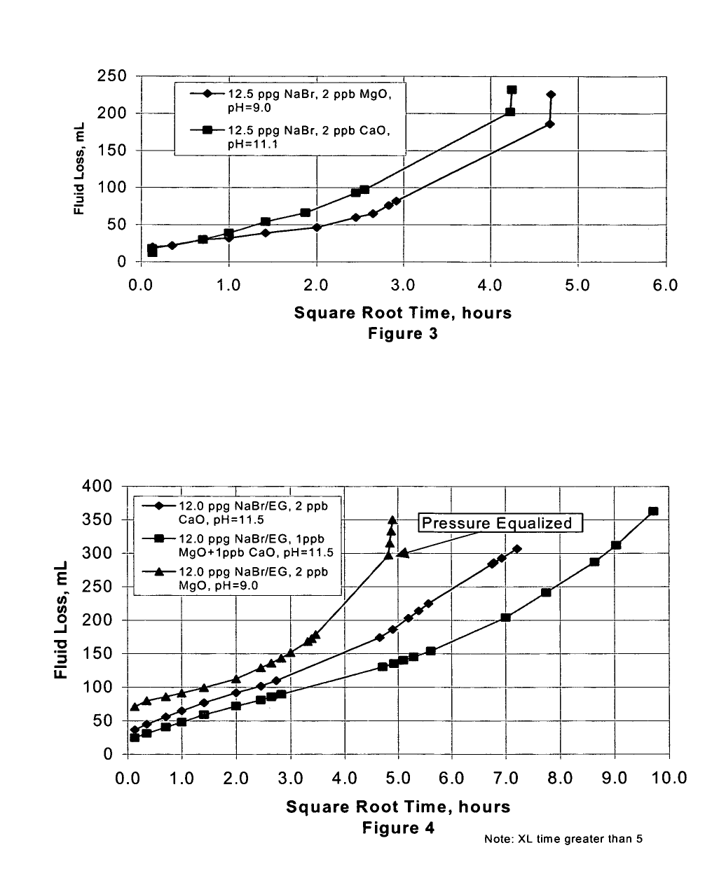

Two solutions were prepared by viscosifying a 12.5 ppg sodium bromide brine with 35 ppb of 12% CMHEC (4.2 ppb CMHEC). To one solution (Solution #6) 2.0 ppb magnesium oxide was added while to the other solution (Solution #7) 2.0 ppb of calcium oxide was added. The pH of Solution #6 was 9.0 while Solution #7 was 11.1. Both solutions were then crosslinked with 15 gptg (gallons per thousand gallons) of zirconium sodium lactate solution and a fluid loss test performed at 350° F. through a 750 md Aloxide disk at 500 psi differential. FIG. 3 shows that both solutions failed to control losses at 24 hours. This can be seen by the large increase in fluid loss within a relatively short period of time.

### Example 25

Three solutions were prepared by viscosifying a solution containing 84.4% by volume of 12.5 ppg sodium bromide brine and 15.6% by volume of ethylene glycol with 35 ppb of 12% CMHEC (4.2 ppb CMHEC). To one solution (Solution #8), 2.0 ppb of magnesium oxide was added, to another (Solution #9), 2.0 ppb calcium oxide was added and to the third (Solution #10) 2.0 ppb of a mixture containing equal weight ratios of magnesium oxide and calcium oxide. All solutions were then crosslinked with 15 gptg (gallons per thousand gallons) of zirconium sodium lactate solution and a fluid loss test performed at 350° F. through a 750 md Aloxite disk at 500 psi differential. FIG. 4 shows that Solution #8 failed to control losses at 24 hours while Solutions #9 and 10 control losses for longer than 48 hours. At about 24 hours for Solution #8, the back pressure was the same as filtration pressure indicating that this formulation was not able to control losses somewhere between 12 and 24 hours since no data was taken during the night. Unexpectedly, the solution with both calcium oxide and magnesium oxide outperformed the solutions containing these buffers alone. Also comparing the results with Solutions #6 and 7, the ethylene glycol increased the thermal stability of the pill.

### Example 26

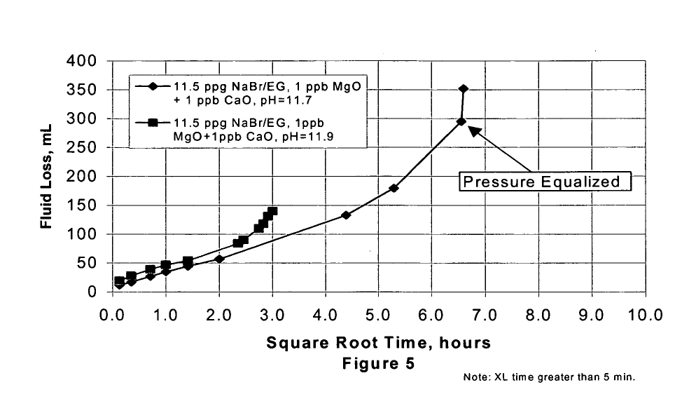

Two solutions were prepared by viscosifying a mixture of 12.5 ppg sodium bromide brine and ethylene glycol with 35 ppb of 12% CMHEC (3.5 ppb CMHEC). One solution (Solution #11) contained 30% by volume of ethylene glycol while the other contained 60% by volume (Solution #12). To both solutions, 1.0 ppb magnesium oxide and 1 ppb of calcium oxide was added. The pH of both solutions was 11.7 to 11.9. Also to both solutions 0.15 ppb of sodium erythorbate was added to increase the crosslink time to over 5 minutes. Then both solutions were crosslinked with 15 gptg of zirconium sodium lactate solution and a fluid loss test performed at 400° F. through a 750 md Aloxide disk at 500 psi differential. The only difference between these solutions is the amount of ethylene glycol and 12.5 ppg sodium bromide brine. FIG. 5 shows that solution containing 60% ethylene glycol (Solution #12) was able to control fluid losses for over 24 hours while Solution #11 which contains less began to thermally degrade at about 6 hours. At about 42 hours the backpressure was the same as the filtration pressure indicating that this formulation could not control losses somewhere between the last data point taken and at about 42 hours.

From the foregoing, it will be observed that numerous variations and modifications may be effected without departing from the true spirit and scope of the novel concepts of the invention.

1. A fluid loss pill comprising:
(a.) cellulosic polymer suspended in an alkali formate solution;
(b.) a crosslinking agent;
(c.) a polyol; and
(d.) brine or water.

2. The fluid loss pill of claim 1, wherein the true crystallization temperature (TCT), API 13 J, of the alkali formate solution is less than or equal to 18° F.

3. The fluid loss pill of claim 1, wherein the alkali formate solution contains between from about 40 to about 75 weight percent of alkali formate.

4. The fluid loss pill of claim 1, wherein the cellulosic polymer is anionic or non-ionic.

5. The fluid loss pill of claim 4, wherein the cellulosic polymer is carboxymethylhydroxyethyl cellulose or hydroxyethyl cellulose, optionally crosslinked with glycoxal.

6. The fluid loss pill of claim 1, wherein the alkali formate is potassium formate, cesium formate, or a mixture thereof.

7. The fluid loss pill of claim 2, wherein the TCT is less than or equal to 0° F.

8. The fluid loss pill of claim 1, wherein the brine has a density greater than or equal to 10.5 ppg at 70° F.

9. The fluid loss pill of claim 1, wherein the crosslinking agent contains a metal ion.

10. The fluid loss pill of claim 9, wherein the crosslinking agent contains zirconium or titanium.

11. The fluid loss pill of claim 9, wherein the crosslinking agent is a borate ion donator.

12. The fluid loss pill of claim 1, wherein the pH of the fluid loss control pill is between from about 3.0 to about 12.0.

13. A method of thickening a brine during the recovery of oil and/or gas from a subterranean formation which comprises introducing into the formation the fluid loss pill of claim 1.

14. A method of reducing fluid loss from a wellbore into a subterranean formation which comprises:
(a.) introducing a crosslinking agent to a polyol, brine or water, and cellulosic polymer suspended in an alkali formate solution; and
(b.) pumping the resulting thickened product of step (a.) into the wellbore.

15. The method of claim 14, wherein the cellulosic polymer suspension, polyol, and brine or water are mixed off-site and shipped to the subterranean formation.

16. The method of claim 14, wherein the brine has a density greater than or equal to 10.5 ppg at 70° F.

17. The method of claim 14, wherein, the pH of the product of step (a.), prior to being pumped into the wellbore, is between from about 3.0 to about 12.0.

18. The method of claim 14, wherein the crosslinking agent contains zirconium, titanium or boron.

19. The method of claim 14, wherein the cellulosic polymer is carboxymethylhydroxyethyl cellulose or hydroxyethyl cellulose, optionally crosslinked with glycoxal.

20. The method of claim 14, wherein the alkali formate is potassium formate, cesium formate, or a mixture thereof.
